(19) United States
(12) Patent Application Publication
(10) Pub. No.: US 2022/0171786 A1
(43) Pub. Date: Jun. 2, 2022

(54) BRANCH OPTIMIZATION METHOD FOR EXECUTION OF BIG DATA ETL (EXTRACT-TRANSFORM-LOAD)

(71) Applicant: Nanjing Beidou Innovation and Application Technology Research Institute Co., Ltd., Nanjing (CN)

(72) Inventors: Zhiqiang DU, Nanjing (CN); Wei GUO, Nanjing (CN); Yuda GUO, Nanjing (CN); Yaxin FAN, Nanjing (CN)

(73) Assignee: Nanjing Beidou Innovation and Application Technology Research Institute Co., Ltd., Nanjing (CN)

(21) Appl. No.: 17/672,867

(22) Filed: Feb. 16, 2022

Related U.S. Application Data
(63) Continuation of application No. PCT/CN2021/112241, filed on Aug. 12, 2021.

(30) Foreign Application Priority Data
Sep. 22, 2020 (CN) 2020110028850

(51) Int. Cl. G06F 16/25; G06F 16/2455

(52) U.S. Cl. CPC G06F 16/254; G06F 16/24552

(57) ABSTRACT

The present invention discloses a branch optimization method for execution of a big data ETL model. The necessity of model execution can be analyzed according to the update characteristics of raw data sets and the characteristics of the ETL model; and optimization judgment is carried out on a plurality of operator branches of the ETL model, and for branches with lower update frequency, a middle repeated calculation process is skipped in a manner of reconstructing a cache table, so that the repeated execution rate is reduced from the operator aspect, the execution efficiency of the ETL model is improved, and the big data analysis is carried out more efficiently.

### CROSS-REFERENCE TO RELATED APPLICATIONS

The application claims priority to Chinese patent application No. 2020110028850, filed on Sep. 22, 2020, the entire contents of which are incorporated herein by reference.

### TECHNICAL FIELD

The present invention relates to the field of big data analysis, and particularly relates to a branch optimization method for execution of a big data ETL (Extract-Transform-Load) model.

### BACKGROUND

ETL (Extract-Transform-Load) is a process of loading data of a business system into a data warehouse after extraction, cleaning and transformation. The purpose of ETL is that scattered, messy and non-uniform data in enterprises is integrated to provide an analysis basis for decision making of the enterprises. ETL is an important link of business intelligence. With the rapid development of the Internet, various industries have accumulated a large number of data assets, and ETL is a first step to analyze the data assets. Due to the large amount of raw data, the complexity of ETL operators and other factors, an ETL model often takes several minutes to tens of minutes of operation. If all the operators in the ETL model are calculated without analysis, there may be more redundant calculations, resulting in a waste of computing resources.

A DAG (Directed Acyclic Graph) refers to a directed graph with no loop. In the graph theory, if a directed graph cannot start from a certain vertex and then go back to the certain vertex through a plurality of sides, the directed graph is a DAG. The dependency relationship of the operators in the ETL model can be expressed as a typical DAG. The ETL model starts from a plurality of data sources, and finally, a plurality of ETL result sets are obtained after the calculation of a unary operator and a binary operator. The flow process of the data always comprises: reading the flow direction of the operators and finally analyzing the result sets, and no loop is formed. Therefore, the characteristics of the DAG of the operators in a business model can be utilized for branch optimization.

### SUMMARY

In order to solve the above problems, the present invention aims to provide a branch optimization method for execution of a big data ETL (Extract-Transform-Load) model.

In order to achieve the above purposes, the present invention adopts the following technical solution:

A branch optimization method for execution of a big data ETL (Extract-Transform-Load) model, wherein the necessity of model execution is analyzed according to the update characteristics of raw data sets and the characteristics of the ETL model; optimization judgment is carried out on a plurality of operator branches of the ETL model; and for branches with lower update frequency, a middle repeated calculation process is skipped in a manner of reconstructing a cache table, so that the repeated execution rate is reduced from the operator aspect, the execution efficiency of the ETL model is improved, and the big data analysis is carried out more efficiently.

Further, wherein the branch optimization comprises two phases; ETL analysis results to be cached are determined in a first phase; and execution states of ETL operators are marked according to cached results in a second phase, and redundant operators are skipped.

A first phase comprises the following specific steps:

S1, disassembling the ETL analysis model into a plurality of ETL branches by taking data sources as starting points and taking analysis results as end points;

S2, marking the ETL branches according to the judgment for the types of the data sources, marking a branch, on which the dynamic data is located, as a high-frequency branch, and marking the branches, on which the static data is located, as low-frequency branches;

S3, judging that whether the correlation operation between the high-frequency branch and the low-frequency branches exists; if no, ending the algorithm without caching; and if yes, going on to the next step;

S4, determining the positions of shortest common nodes of the high-frequency branch and the low-frequency branches; and

S5, caching precursor nodes of the shortest common nodes on the low-frequency branches;

through adoption of the above steps, the analysis results to be cached in the branch optimization method of the ETL model are determined; and when the ETL model is executed actually, the corresponding ETL analysis results are cached, so as to prepare for a marking phase of subsequent branch optimization.

The second phase comprises the following specific steps:

S2.1, judging that whether the ETL analysis results and caches fail or not according to the update time of the input data sources and carrying out marking;

S2.2, searching the precursor nodes in a recursion manner until the data sources at roots by taking the ETL results and the caches as starting points and constructing reverse analysis chains;

S2.3, carrying out marking according to that whether the ETL results and the caches fail or not from the starting point of the reverse analysis chains; if yes, sequentially marking a current node and subsequent nodes thereof as EXCUTE (representing that the operator needs to be executed); if no, marking a current node as RECONSTRUCT (representing that a calculation result of the operator is stored as a result table or a cache table; and if no, reconstructing the operator and reading a cached result), and marking subsequent nodes thereof as SKIP (representing that the operator may be a redundant operator and is skipped and not executed); and if other result tables and cache tables also exist except the starting points, going on to mark the subsequent nodes according to that whether other result tables and cache tables fail or not; and

S2.4, combining marking results of all the reverse analysis chains, wherein if one reverse analysis chain is marked as EXECUTE, the final marking result of the nodes of the operator is EXECUTE; and if the operator is marked as SKIP by all the reverse analysis chains, the final marking result is SKIP.

The present invention has the beneficial effects that:

Compared with the prior art, in the branch optimization method for execution of the big data ETL model, the necessity of model execution can be analyzed according to the update characteristics of raw data sets and the characteristics of the ETL model; and optimization judgment is carried out on a plurality of operator branches of the ETL model, and for branches with lower update frequency, a middle repeated calculation process is skipped in a manner of reconstructing a cache table, so that the repeated execution rate is reduced from the operator aspect, the execution efficiency of the ETL model is improved, and the big data analysis is carried out more efficiently.

### BRIEF DESCRIPTION OF DRAWINGS

FIG. 1 is a flow chart of a first phase of the present invention;

FIG. 2 is a flow chart of a second phase of the present invention; and

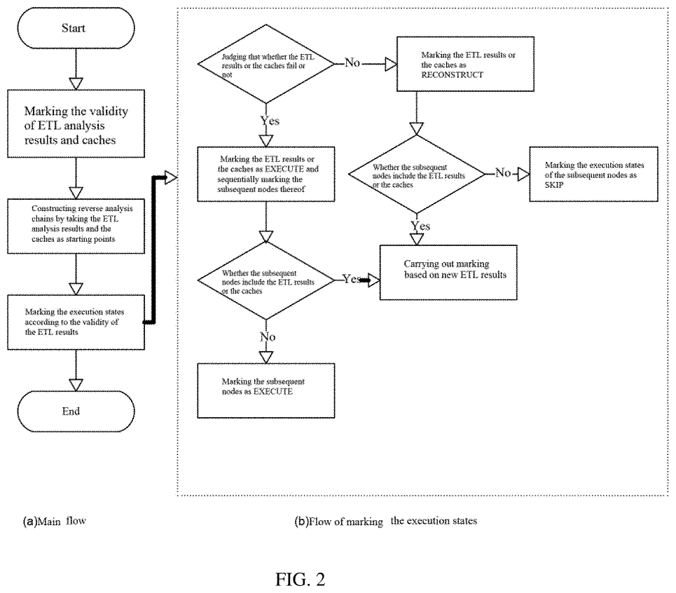

FIG. 3 is a schematic diagram of branch optimization.

### DETAILED DESCRIPTION OF THE EMBODIMENTS

The present invention is further described hereinafter in combination with the drawings:

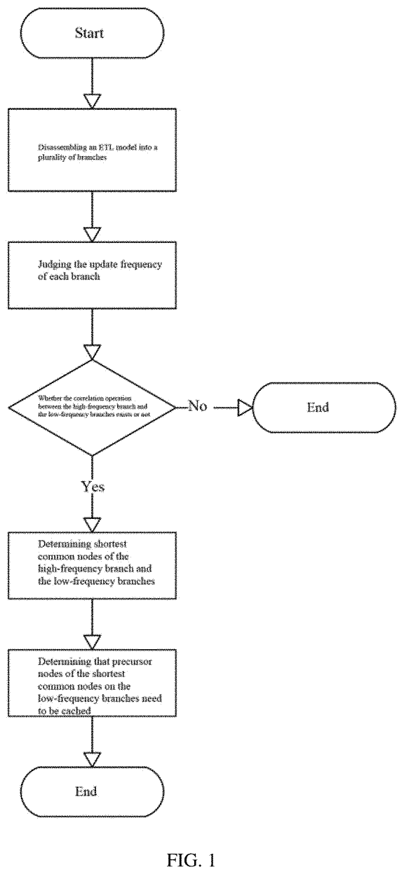

As shown in FIG. 1: according to an analysis on the characteristics of a data set, the data set comprises two types of data sets: a stable data set and an active data set; data of the stable data set is stable in time intervals with hours or days as a unit and does not change frequently; data of the active data set is active in time intervals with minutes or hours as a unit, and new data records are constantly added into a raw data set; however, an ETL (Extract-Transform-Load) analysis model is executed regularly, the data is automatically submitted and run according to the preset time after raw data is updated, and therefore, the ETL model is executed repeatedly in a certain time period; when correlation operation is carried out on dynamic data and static data, for the static data, a data set thereof does not change possibly; but as the dynamic data is updated, an ETL analysis on the static data is promoted; and if branches, on which the static data is located, can be cached, redundant calculations can be reduced to a certain degree. A branch optimization technology comprises two phases; ETL analysis results to be cached are determined in a first phase; and execution states of ETL operators are marked according to cached results in a second phase, and redundant operators are skipped.

The first phase comprises the following specific steps:

S1, disassembling the ETL analysis model into a plurality of ETL branches by taking data sources as starting points and taking analysis results as end points;

S2, marking the ETL branches according to the judgment for the types of the data sources, marking a branch, on which the dynamic data is located, as a high-frequency branch, and marking the branches, on which the static data is located, as low-frequency branches;

S3, judging that whether the correlation operation between the high-frequency branch and the low-frequency branches exists; if no, ending the algorithm without caching; and if yes, going on to the next step;

S4, determining the positions of shortest common nodes of the high-frequency branch and the low-frequency branches; and

S5, caching precursor nodes of the shortest common nodes on the low-frequency branches.

Through adoption of the above steps, the analysis results to be cached in the branch optimization method of the ETL model are determined; and when the ETL model is executed actually, the corresponding ETL analysis results are cached, so as to prepare for a marking phase of subsequent branch optimization.

The second phase comprises the following specific steps:

S2.1, judging that whether the ETL analysis results and caches fail or not according to the update time of the input data sources and carrying out marking;

S2.2, searching the precursor nodes in a recursion manner until the data sources at roots by taking the ETL results and the caches as starting points and constructing reverse analysis chains;

S2.3, carrying out marking according to that whether the ETL results and the caches fail or not from the starting point of the reverse analysis chains; if yes, sequentially marking a current node and subsequent nodes thereof as EXCUTE (representing that the operator needs to be executed); if no, marking a current node as RECONSTRUCT (representing that a calculation result of the operator is stored as a result table or a cache table; and if no, reconstructing the operator and reading a cached result), and marking subsequent nodes thereof as SKIP (representing that the operator may be a redundant operator and is skipped and not executed); and if other result tables and cache tables also exist except the starting points, going on to mark the subsequent nodes according to that whether other result tables and cache tables fail or not; and

S2.4, combining marking results of all the reverse analysis chains, wherein if one reverse analysis chain is marked as EXECUTE, the final marking result of the nodes of the operator is EXECUTE; and if the operator is marked as SKIP by all the reverse analysis chains, the final marking result is SKIP.

The main idea of the technical solution of the present invention is that: based on that the ETL model needs to be executed actually is determined, optimization judgment is carried out on the operator branches of the ETL model; and for the branches with lower update frequency, a middle repeated calculation process is skipped in a manner of reconstructing the cache table, so that the repeated execution rate is reduced from the aspect of the ETL operators, and the analysis efficiency of an ETL business model is improved.

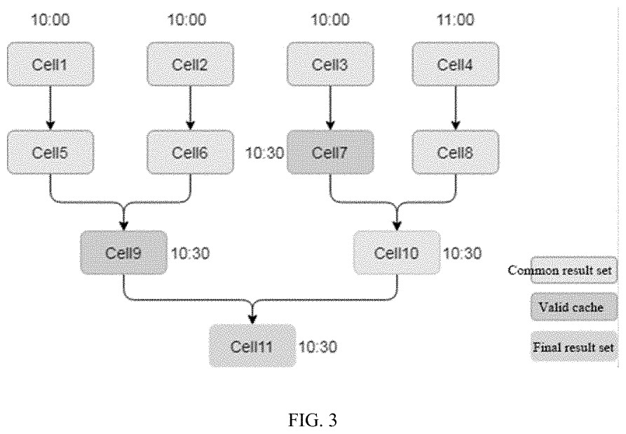

A schematic diagram represented in FIG. 3 is taken as an example. When in specific implementation, the flow comprises the following steps:

A first phase:

S1, disassembling the ETL analysis model into four ETL branches by taking data sources as starting points and taking analysis results as end points;

S2, marking the ETL branches according to the judgment for the types of the data sources, marking the branch, on which the dynamic data is located, as a high-frequency branch (Cell4), and marking the branches, on which the static data is located, as low-frequency branches (Cell1, Cell2 and Cell3);

S3, judging that whether the correlation operation between the high-frequency branch and the low-frequency branches exists;

S4, determining the positions (Cell10 and Cell11) of shortest common nodes of the high-frequency branch and the low-frequency branches; and

S5, caching precursor nodes (Cell7 and Cell9) of the shortest common nodes on the low-frequency branches.

A second phase:

S2.1, judging that whether the ETL analysis results and caches fail or not according to the update time of the input data sources and carrying out marking, wherein Cell7 and Cell19 are valid, and Cell11 fails;

S2.2, searching the precursor nodes in a recursion manner until the data sources at roots by taking Cell11 as a starting point and constructing reverse analysis chains, wherein four reverse analysis chains are constructed: Cell11 (invalid)→Cell9 (valid)→Cell5→Cell1, Cell11 (invalid)→Cell9 (valid)→Cell6→Cell2, Cell11 (invalid)→Cell10→Cell7 (valid)→Cell3, and Cell11 (invalid)→Cell10→Cell8→Cell4;

S2.3, carrying out marking according to that whether the ETL results and the caches fail or not from the starting point of the reverse analysis chains, wherein for example, the analysis chain: Cell11 (invalid)→Cell9 (valid)→Cell5→Cell1 is marked; as Cell11 is invalid, the state thereof is EXECUTE; and as Cell9 is valid, the state thereof is RECONSTRUCT, and the execution states of the subsequence nodes thereof Cell5 and Cell1 are SKIP; and

S2.4, combining marking results of all the reverse analysis chains and finally obtaining the execution states of all the operators, wherein the execution states of Cell1, Cell2, Cell3, Cell5 and Cell6 are SKIP; the execution states of Cell7 and Cell9 are RECONSTRUCT; and the execution states of Cell4, Cell8, Cell10 and Cell11 are EXECUTE.

The basic principle, main features and advantages of the present invention are shown and described above. Those skilled in the art should understand that the present invention is not limited by the above embodiments, and the above embodiments and the descriptions in the description are only used for explaining the principle of the present invention; and various changes and improvements can be made to the present invention without departing from the spirit and scope of the present invention, and the changes and improvements belong to the required protection scope of the present invention. The required protection scope of the present invention is defined by the appended claims and the equivalents thereof.

What is claimed is:

1. A branch optimization method for execution of a big data ETL model, wherein the necessity of model execution is analyzed according to the update characteristics of raw data sets and the characteristics of the ETL model; optimization judgment is carried out on a plurality of operator branches of the ETL model; and for branches with lower update frequency, a middle repeated calculation process is skipped in a manner of reconstructing a cache table, so that the repeated execution rate is reduced from the operator aspect, the execution efficiency of the ETL model is improved, and the big data analysis is carried out more efficiently.

2. The branch optimization method for execution of the big data ETL model according to claim 1, wherein the branch optimization comprises two phases; ETL analysis results to be cached are determined in a first phase; and execution states of ETL operators are marked according to cached results in a second phase, and redundant operators are skipped.

3. The branch optimization method for execution of the big data ETL model according to claim 2, wherein the first phase comprises the following specific steps:
S1, disassembling the ETL analysis model into a plurality of ETL branches by taking data sources as starting points and taking analysis results as end points;
S2, marking the ETL branches according to the judgment for the types of the data sources, marking a branch, on which the dynamic data is located, as a high-frequency branch, and marking the branches, on which the static data is located, as low-frequency branches;
S3, judging that whether the correlation operation between the high-frequency branch and the low-frequency branches exists; if no, ending the algorithm without caching; and if yes, going on to the next step;
S4, determining the positions of shortest common nodes of the high-frequency branch and the low-frequency branches; and
S5, caching precursor nodes of the shortest common nodes on the low-frequency branches;
through adoption of the above steps, the analysis results to be cached in the branch optimization method of the ETL model are determined; and when the ETL model is executed actually, the corresponding ETL analysis results are cached, so as to prepare for a marking phase of subsequent branch optimization.

4. The branch optimization method for execution of the big data ETL model according to claim 2, wherein the second phase comprises the following specific steps:
S2.1, judging that whether the ETL analysis results and caches fail or not according to the update time of the input data sources and carrying out marking;
S2.2, searching the precursor nodes in a recursion manner until the data sources at roots by taking the ETL results and the caches as starting points and constructing reverse analysis chains;
S2.3, carrying out marking according to that whether the ETL results and the caches fail or not from the starting point of the reverse analysis chains; if yes, sequentially marking a current node and subsequent nodes thereof as EXCUTE; if no, marking a current node as RECONSTRUCT, and marking subsequent nodes thereof as SKIP; and if other result tables and cache tables also exist except the starting points, going on to mark the subsequent nodes according to that whether other result tables and cache tables fail or not; and
S2.4, combining marking results of all the reverse analysis chains, wherein if one reverse analysis chain is marked as EXECUTE, the final marking result of the nodes of the operator is EXECUTE; and if the operator is marked as SKIP by all the reverse analysis chains, the final marking result is SKIP.
